(19) United States
(12) Patent Application Publication
(10) Pub. No.: US 2005/0017465 A1
(43) Pub. Date: Jan. 27, 2005

(54) Wear rod for a snowmobile ski

(75) Inventor: Scott T. Bergstrom, Roscoe, IL (US)

Correspondence Address: LEYDIG VOIT & MAYER, LTD, 6815 WEAVER ROAD, ROCKFORD, IL, 61114-8018, US

(73) Assignee: Bergstrom Skegs, Inc., Machesney Park, IL (US)

(21) Appl. No.: 10/626,067

(22) Filed: Jul. 24, 2003

(51) Int. Cl. B62B 17/02

(52) U.S. Cl. 280/28

(57) ABSTRACT

A wear rod for a snowmobile ski is provided that contains multiple wear edges. The wear rod includes a longitudinally extending host bar having longitudinally extending grooves. Strips of a harder second material are integrally mounted in the grooves to increase the wear resistance of the wear rod. The strips define wear edges that contact the trail surface as the snowmobile turns or moves in a straight direction. The wear edges are located such that as the snowmobile ski turns, the wear rod cants and a portion of the load of the snowmobile shifts from one wear edge to another wear edge. The wear edges are also arranged such that the wear edges are self-sharpening to maintain the functional life of the wear rod.

### FIELD OF THE INVENTION

The present invention relates generally to snowmobiles, and more particularly relates to wear rods for snowmobile skis.

### BACKGROUND OF THE INVENTION

Snowmobiles have a pair of skis at the front end. The skis are adapted to ride over snow material. The skis have mounting shoes towards the center of the ski for mounting to the front suspension posts of the snowmobile and an upwardly curved ski tip for keeping the ski afloat on the snow surface. A wear rod, which serves several functions, is attached to the underside of the ski. Primarily, the wear rod protects the ski from being damaged and extends the life span of the ski. The wear rod protects the ski from hard debris such as rocks or logs that may be hidden under the snow. The wear rod also keeps the bottom of the ski from coming in contact with trail surfaces when the snow is thin or when snow is not present, such as when crossing a road, a driveway, or a sidewalk. Additionally, the wear rod assists the ski in turning the snowmobile.

Current wear rods typically consist of a rigid member and sometimes an additional harder wear material that increases the durability and wear life of the wear rod. The rigid member is typically referred to as a host bar and is generally steel. The additional wear material is either a hard surfacing material and attached in the form of a welded bead to the bottom of the host bar or is a carbide strip which is typically integrally attached to the host bar with solder. As described and shown in “Wear Rod Models—Bergstrom Skegs, Inc.,” at the website address http://www.bergstromskegs.com/wr/models.htm and as provided by Hardsurfaced wear rod models and Carbide Type I-V wear rod models, which are commercially available from Bergstrom Skegs, Inc. out of Rockford, Ill., a wear rod with an additional wear material provides a wear life of several times longer than that of a standard wear rod. Also, as provided in the Carbide Type I-V wear rod models of Bergstrom Skegs, carbide is often used in wear rods to provide a sharp bottom most edge that substantially assists turning while on icy trail surfaces.

As provided in the Carbide Type I-V wear rod models, the wear rod has a single carbide strip comprising a single sharp bottom most wear edge that contacts the trail surface. The sharp wear edge increases the steering performance and safety of the snowmobile, particularly while turning on ice. Unfortunately, a drawback of this design is that the load of the snowmobile always rides on the sharp wear edge. Consequently, when the snowmobile is moving in a straight direction while in shallow snow or while crossing roads, driveways or sidewalks where no snow exists, the sharp wear edge becomes dull. At these times, the wear rod appropriately performs its function of preventing the ski from contacting the trail surface and being worn. However, the sharp wear edge is being worn reducing the additional handling that the sharp wear edge provides. Furthermore, the sharp wear edge, being the bottom most portion, will carve into pavement or concrete surfaces at road crossings, gas stations, and driveways damaging both the trail surface and the wear rod. Additionally, the snowmobile uses the single wear edge to turn in both directions. By manipulating the ski when turning both directions, the sharp edge and the carbide strip becomes rounded rather than maintaining a sharp edge which can engage the trail surface while turning.

### BRIEF SUMMARY OF THE INVENTION

The invention is directed toward a wear rod with multiple wear edges. The wear rod comprises a longitudinal extending body known as a host bar which is typically formed from steel, a wear resistant material harder than the host bar material extending longitudinally a substantial length along the host bar which is typically formed from carbide, multiple wear edges formed by the wear resistant material; and at least one channel formed between the edges.

It is a feature of this invention that the channel or channels assist the penetration of the trail surface by the wear edges while turning, therefore, increasing the grab and “bite” of the wear rod.

It is a feature of a particular embodiment of the invention, which includes an intermediate wear edge formed between two outer side wear edges, that the intermediate wear edge, being the bottom most portion of the wear rod may be located at an elevation below that of the outer side wear edges. While traveling in a straight direction, this arrangement prevents the outer side wear edges from contacting the trail surface. Consequently, the intermediate wear edge carries the load of the snowmobile avoiding unnecessary wear to the outer side wear edges. While turning, the wear rod cants and an outer side wear edge is presented to and engages the trail surface shifting some of the load of the snowmobile to the outer side wear edge improving the ability of the snowmobile to turn.

It is a further feature of a particular embodiment of this invention, which includes an intermediate wear edge in the form of a flat bottom wear surface formed between two corners, that the corners also assist the turning of the snowmobile. As the wear rod cants, the corners create an additional edge that engages the trail surface increasing the grab or bite of the wear rod.

It is a feature of an embodiment of the invention that the flat bottom wear surface aids in preventing the wear rod from penetrating hard trail surfaces, such as driveways, sidewalks or roads while traveling in a straight direction. This feature protects both the trail surface, as well as the wear rod.

It is a further feature of certain embodiments that the increased width of the wear resistant material almost eliminates wear of the host bar, as compared to a typical wear rod having wear resistant material.

It is a feature of certain embodiments of the invention that the wear edges are self-sharpening. The wear edges self-sharpen by wearing flat and planar to the trail surface rather than round. By wearing flat, the wear edges create or maintain sharp corners or edges for an extended length of time, which may engage the trail surface and assist turning, thereby, extending the functional wear life of the wear rod.

In an additional embodiment of the invention, the wear rod comprises an intermediate wear edge forming a sharp bottom wear edge and two outer side wear edges. The sharp bottom wear edge provides increased penetration by the wear rod and increased handling which allows for more aggressive riding. This embodiment places all three carbide edges in the center of the ski allowing at least two carbide edges to make contact in a corner as the ski cants. Furthermore, unlike the current wear rods that have only a center sharp edge and no outer side wear edges, the outer side wear edges of this embodiment of the disclosed invention protect the intermediate wear edge, and the intermediate wear edge will wear flat rather than round. By wearing flat, this embodiment will also undergo some self-sharpening, further extending the life and function of the wear rod as compared to current wear rods.

Other aspects, objectives and advantages of the invention will become more apparent from the following detailed description when taken in conjunction with the accompanying drawings.

### BRIEF DESCRIPTION OF THE DRAWINGS

FIG. 1 is an exploded isometric view of a snowmobile ski incorporating a wear rod in accordance with the disclosed invention.

FIG. 2 is an enlarged profile view of the wear rod of FIG. 1.

FIG. 3 is a cross-sectional view of a particular embodiment of the wear rod of FIG. 2 having two outer side wear edges and an intermediate wear edge formed from three carbide strips, wherein the intermediate wear edge forms a flat bottom wear surface.

FIG. 4 is a cross-sectional view of a particular embodiment of the wear rod of FIG. 2 having two outer side wear edges and an intermediate wear edge formed from three carbide strips, wherein, the intermediate wear edge forms a sharp bottom wear edge.

FIG. 5 is a cross-sectional view of a particular embodiment of a wear rod similar to the wear rod of FIG. 3 having the two outer side wear edges and the intermediate wear edge unitarily formed in a single carbide strip.

FIG. 6 is a cross-sectional view of a particular embodiment of a wear rod similar to the wear rod of FIG. 4 having the two outer side wear edges and the intermediate wear edge unitarily formed in a single carbide strip.

FIG. 7 is a cross-sectional view of a particular embodiment of a wear rod similar to the wear rod of FIG. 4 having only the two outer side wear edges.

FIG. 8 is a cross-sectional view of a pair of wear rods in a particular embodiment similar to the wear rod of FIG. 4 with each wear rod of the pair having only a single outer side wear edge and a single intermediate wear edge forming a sharp bottom wear edge.

FIG. 9 is a cross-sectional view of FIG. 1 illustrating the cant of the wear rod as the snowmobile ski turns.

FIG. 10 is a cross-sectional view of a particular embodiment of the wear rod of FIG. 1 generally illustrating the self-sharpening features of the wear edges of this invention.

### DETAILED DESCRIPTION OF THE INVENTION

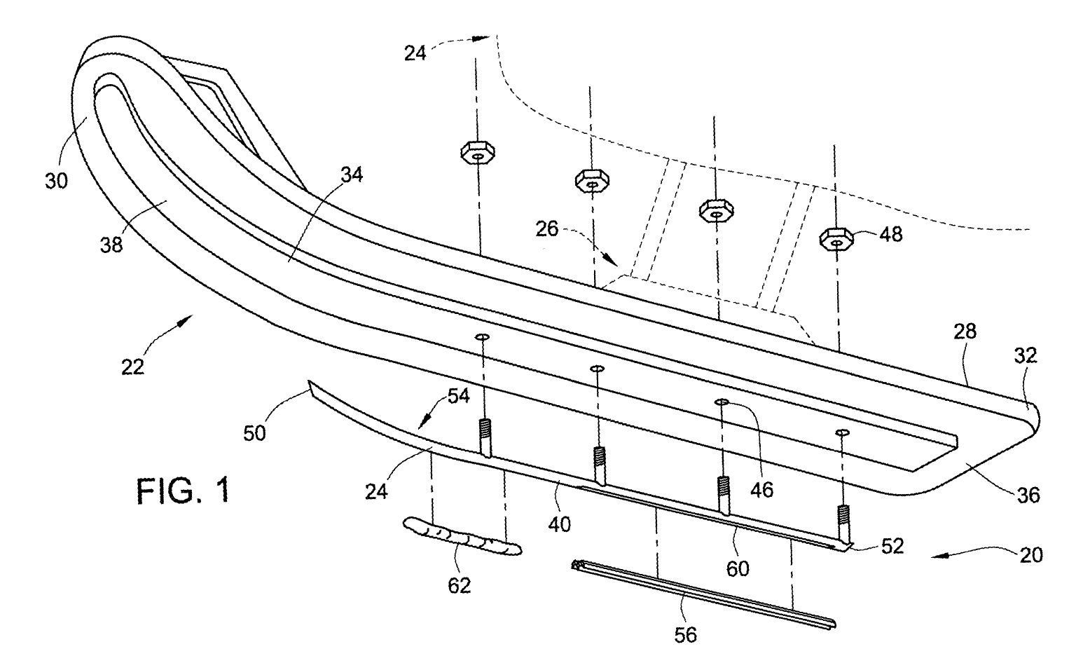

For purposes of illustration, a preferred embodiment of the present invention has been illustrated as a wear rod 20 for mounting to the underside of a snowmobile ski 22 as shown in FIG. 1. The wear rod 20 protects the snowmobile ski 22 from damage and wear while increasing the life and handling characteristics of the snowmobile ski 22.

The snowmobile ski 22 is of conventional design and may be fabricated from plastic or steel and can be of any suitable shape. To attach the snowmobile ski 22 to the front of the snowmobile 24, a mounting shoe 26 is attached to the topside 28 of the snowmobile ski 22. For purposes of reference, the snowmobile ski 22 extends longitudinally between an upwardly bent front tip 30 and a generally planar rear body 32. A center keel 34 is integrally provided along the underside 36 of the snowmobile ski 22 and projects vertically downward to aid the turning of the snowmobile 24. The center keel 34 is designed to engage snow and is the primary component for digging into the snow to turn the snowmobile 24. As a result, the center keel 34 typically has the greatest potential to contact trail surfaces, road surfaces or debris under the snow and is typically a source of a large amount of wear. As the center keel 34 is formed to the shape of the snowmobile ski 22 and extends substantially the entire longitudinal length of the snowmobile ski 22, the front end 38 of the center keel 34 also bends upward.

The wear rod 20 is secured to the underside of the center keel 34 and thereby forms the bottom most portion of the snowmobile ski 22. With this arrangement, the wear rod 20 prevents the center keel 34 from being damaged and worn. The wear rod 20 also assists the snowmobile ski 22 in turning the snowmobile 24 on hard trail surfaces, such as where the snow is thin or on ice. The wear rod 20 is removably secured to the underside of the center keel 34 using threaded posts 42 or other suitable securing mechanisms. The threaded posts 42 are integrally attached to the host bar 40 and extend through holes 46 in the center keel 34. Nuts 48 secured onto the threaded posts 42 removably attach the wear rod 20 to the underside of the center keel 34. The host bar 40 extends longitudinally between a front tip 50 and a rear tip 52 and is typically curved slightly along its longitudinal length to better conform to the slightly curved contour of the ski bottom. The front tip 50 and rear tip 52 of the host bar 40 may be beveled, as illustrated, to prevent the wear rod 20 from being caught on debris and slowing the snowmobile 24 or from being caught while loading and unloading the snowmobile from a trailer. As the host bar 40 is bent to the shape of the center keel 34, the front end 54 of the host bar 40 is generally upwardly bent. By having the front end 54 upwardly bent, the host bar 40 facilitates protection of the snowmobile ski 22 and aids traversing over larger debris, such as logs or large rocks that may be hidden under the snow.

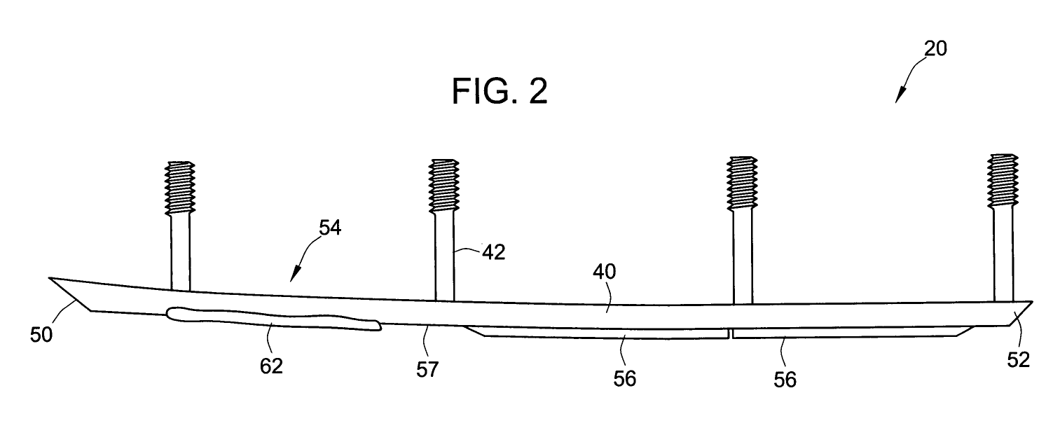

As shown, the host bar 40 may be formed from round steel rod. To increase the wear resistance of the wear rod 20, carbide strips 56 are integrally mounted to the bottom 57 of the host bar 40 as illustrated by FIGS. 1 and 2. If desired, the bottom 57 of the host bar 40, where no carbide strips 56 are mounted, may be covered with a welded bead of a hard surfacing material 62 to provide additional wear resistance for the wear rod 20.

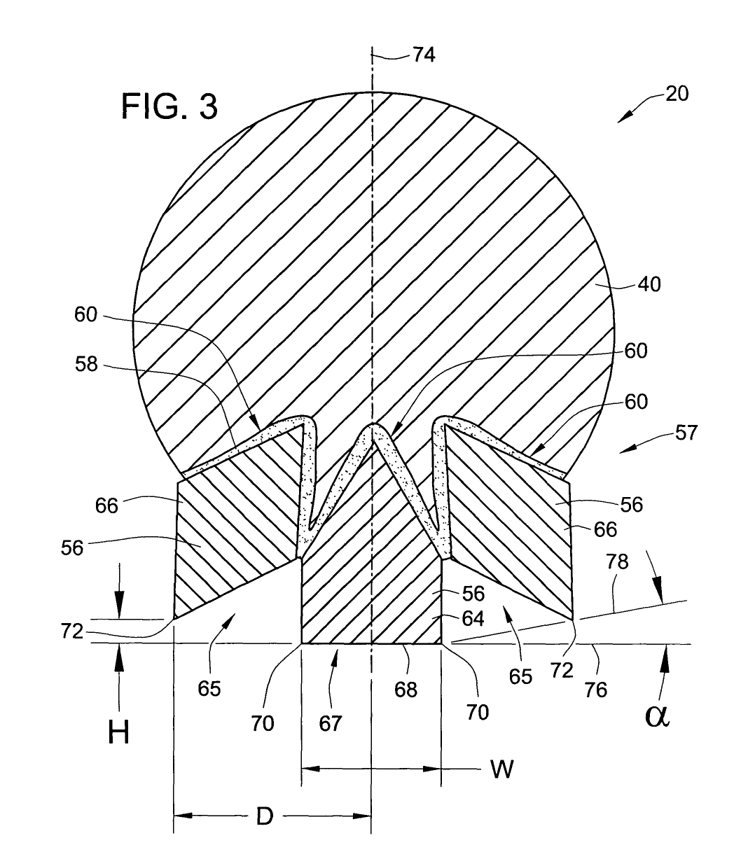

In accordance with the present invention, the embodiment of FIG. 1 provides multiple surface engaging wear edges with a plurality of carbide strips 56. In this embodiment grooves 60 are formed in and extend longitudinally a substantial length along the bottom 57 of the host bar 40 to facilitate mounting of the carbide strips 56. Solder 58 (see FIG. 3) is used between the host bar 40 and the carbide strips 56 to integrally secure the carbide strips 56 in the grooves 60 formed in the host bar 40.

The grooves 60 increase the joint strength between the host bar 40 and the carbide strips 56 by increasing the surface area of the host bar 40 and the carbide strips 56 for the solder 58 to adhere to as illustrated in FIG. 3. The grooves 60 inset a portion of the carbide strips 56 in the host bar 40, which provides additional host bar 40 material around the carbide strips 56. The additional material increases the wear life of the wear rod 20 because more material must be worn away before the solder 58 becomes exposed to wear. Wear to the solder 58 enables the carbide strips 56 to dislodge from the host bar 40 substantially eliminating the functionality of the wear rod 20. Additionally, as the snowmobile turns, the carbide strips 56 are exposed to substantial lateral forces. The grooves 60 create walls that provide substantial lateral support for the lateral loading of the carbide strips 56, particularly while turning. The presence of lateral support increases the amount of lateral force that the wear rod 20 may withstand before failure, particularly failure to the solder bonds between the host bar 20 and the carbide strips 56.

In the preferred embodiment illustrated in FIG. 3, three side-by-side grooves 60 are formed in the host bar 40 to accept three carbide strips 56, including an intermediate strip 64 and two outer strips 66. The intermediate strip 64 and two outer strips 66 are mounted in the three grooves 60 in parallel relation. 66. In this embodiment, the intermediate strip 64 includes an intermediate wear edge 67 in the form of a flat bottom wear surface 68 formed between two corners 70. The two outer strips 66 include an outer side wear edge 72 in the form of a sharp wear edge. Two channels 65 separate the intermediate wear edge 68 from the two outer side wear edges 72. The flat bottom wear surface 68 is the bottom most portion of the wear rod and projects vertically downward to an elevation H between about 0 inch and 0.05 inch below the elevation of the outer side wear edges 72 of the outer strips 66. The flat bottom wear surface 68 having a width W between about 0.1 inch to about 0.4 inch. The outer side wear edge 72 of each of the outer strips 66 is positioned a distance D between about 0.2 inch to about 0.3 inch from a vertical axis 74. An angle α is defined between a horizontal plane 76 and a plane 78 defined by the outer side wear edge 72 of the outer strips 66 and a corner 70 of the flat bottom wear surface 68 of the intermediate wear edge 67. Preferably, width W, elevation H and distance D are determined such that the angle α is about equal to or less than the degree of cant that the wear rod 20 exhibits as the snowmobile ski turns. For most snowmobiles, this α angle is approximately 10 degrees, and typically in the range of between about 8 degrees and about 15 degrees.

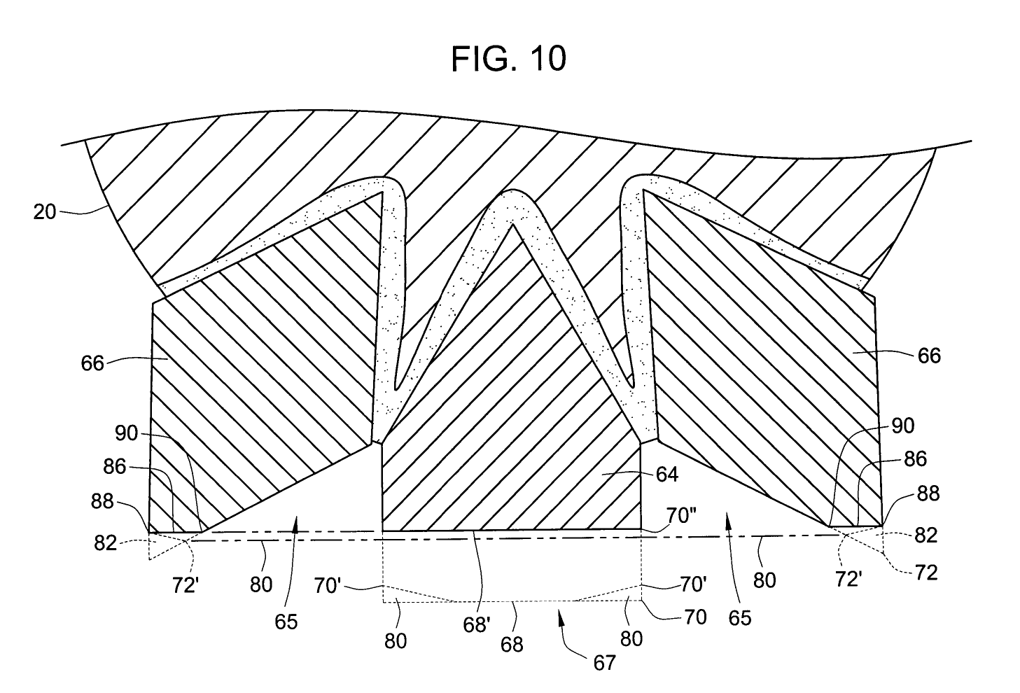

In this embodiment, while the snowmobile moves forward with the snowmobile skis pointed straight, the snowmobile only rides on the intermediate wear edge 67, and the outer side wear edges 72 of the outer strips 66 do not contact the trail surface 75, as illustrated by the dashed lines in FIG. 9. Therefore, the intermediate wear edge 67 bears the loads of the snowmobile, and only, the intermediate wear edge 67 of the intermediate strip 64 is worn. As the snowmobile ski turns to steer the snowmobile, the snowmobile ski begins to tilt, and consequently, the wear rod 20 cants. In FIG. 9, the canted wear rod 20′ is illustrated by the solid lines. As the wear rod 20′ cants, the outer side wear edge 72′ of one of the outer strips 66′ is presented to the trail surface 75, consequently, part of the load of the snowmobile 24 shifts to one of the outer side wear edges 72 of one of the outer strips 66 as illustrated in FIG. 9. It should be noted that one skilled in the art would realize that the particular relative lateral positioning of the un-canted wear rod 20 and canted wear rod 20′ is merely for illustration purposes. The actual lateral positioning may be laterally shifted depending on the snowmobile ski's center of tilt.

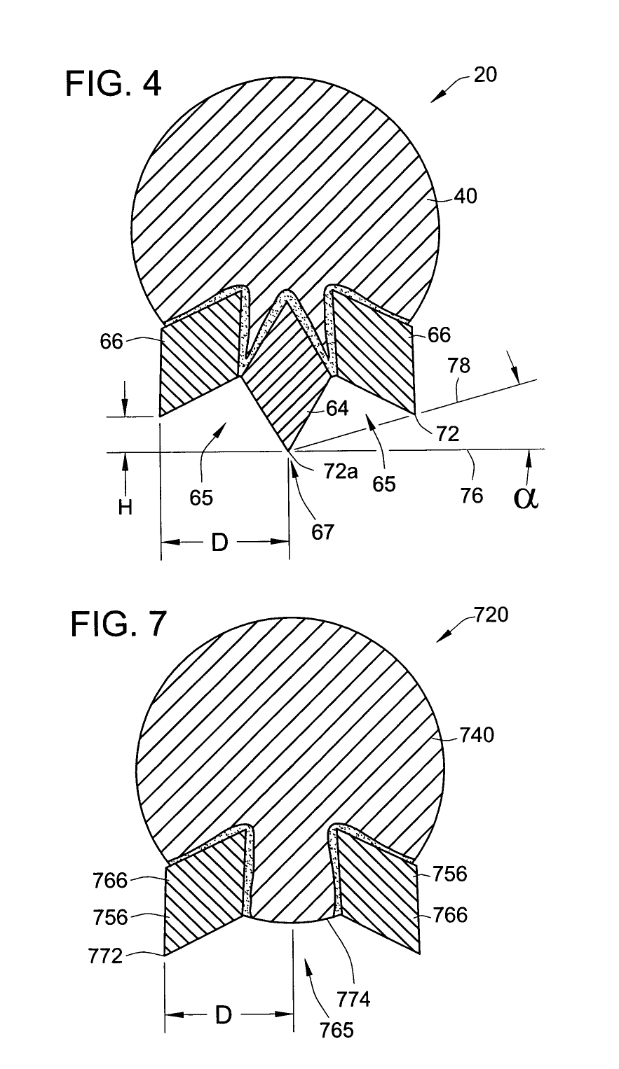

For maximum wear resistance and general use, the preferred intermediate strip 64 comprises an intermediate wear edge 67 forming a flat bottom wear surface 68, between two corners 70 in the horizontal plane 76, as shown in FIG. 3. The two outer strips 66 have an outer side wear edge 72 that form a sharp edge. The intermediate wear edge 67 with a flat bottom wear surface 68 of width W between about 0.1 inch to about 0.4 inch is preferred because it has an increased wear surface when the snowmobile is moving forward. As compared to a wear edge that would come to a sharp edge similar to the sharp bottom wear edge 72a of the intermediate wear edge 67 in FIG. 4, the increased width of the flat bottom wear surface 68 distributes the load of the snowmobile over a larger area reducing the contact pressure of the wear rod 20 as it contacts the trail surface. The reduced contact pressure aids in preventing the wear rod 20 from penetrating into trail surfaces, such as driveways, sidewalks, or roads while the snowmobile is moving in a straight direction. This prevents damage to both the wear rod 20 and the traversed trail surfaces. Also, the flat bottom wear surface 68 increases the amount of material that must be worn away before the wear rod 20 loses utility, consequently, increasing the wear life of the wear rod 20.

The sharp outer side wear edge 72 of the outer strips 66 is preferred because the outer side wear edge 72 maintains the handling characteristics of the snowmobile ski. The sharp outer side wear edge 72 increases the penetration of the wear rod 20 into the trail surface when turning, particularly on hard trail surfaces such as ice. The increased penetration assists the wear rod 20 in engaging the hard trail surface and improves the “bite” or grab of the wear rod 20. While the wear rod 20 cants, one of the two corners 70 of the intermediate wear edge 67 may also assist the wear rod 20 in engaging the trail surface (see FIG. 9). If the outer strips 66 penetrate the trail surface to a substantial depth while the wear rod 20 is canted or if the sharp outer side wear edges 72 of the outer strips 66 wear, dull or break, the corners 70 of the intermediate wear edge 67 act as a second edge to aid in turning and maneuvering by presenting an additional edge, the corner 70, that engages the trail surface 75.

FIG. 10 illustrates the self-sharpening feature of this invention. As the snowmobile turns and the wear rod 20 cants, material 80, 82 is worn and removed from the intermediate strip 64 and the outer strips 66, respectively. The wear creates worn corners 70′ of the intermediate wear edge 67 and worn outer side wear edges 72′ of the outer strips 66. Fortunately, the worn corners 70′ and worn outer side wear edges 72′ will experience some self-sharpening when the snowmobile moves in the forward direction. The self-sharpening of the worn corners 70′ occurs because the flat bottom wear surface 68 of the intermediate wear edge 67 generally planar and parallel to the trail surface. As the intermediate wear edge 67 comes in contact with the trail surface 75, the hard trail surface 75 acts similar to a grinding stone and a new flat bottom wear surface 68′ and new corners 70″ are formed.

Some self-sharpening of the worn outer side wear edge 72′ of the outer strips 66 also occurs while the snowmobile is traveling in a straight direction. After the intermediate wear edge 67 wears such that the new flat bottom wear surface 68′ and the worn outer side wear edges 72′ are at equal elevations, such as at horizontal plane 84, the worn outer side wear edges 72′ of the outer strips 66 will now also contact the trail surface and wear. As the worn outer side wear edge 72′ wears, it will wear flat in the horizontal plane 84 and undergo some self-sharpening. As the worn outer side wear edge 72′ wears flat, a flat surface 86 is created between an outer edge 88 and an inner corner 90. Now, when the wear rod 20 cants as the snowmobile ski turns, the outer edge 88 will present a sharp edge to the trail surface. The ability of the wear rod to maintain and create a new sharp edge is a significant feature that greatly increases the service life and function of the wear rod 20.

A more aggressive alternate embodiment of the invention provides increased handling and is illustrated in FIG. 4. This embodiment is similar in certain respects to the embodiment in FIG. 3 and includes by reference many of the same characteristics as the prior embodiment except for those further explained and distinguished. A major change in this embodiment is that the intermediate strip 64 forms an intermediate wear edge 67 having a sharp bottom wear edge 72a rather than a flat bottom wear surface. The sharp bottom wear edge 72a is substantially similar to the sharp outer side wear edge 72 of the outer strips 66. The dimensioning of this embodiment is substantially similar to dimensioning of the embodiment in FIG. 3. However, the angle α is defined between a horizontal plane 76, which includes the sharp bottom wear edge 72a, and a plane 78 defined by the bottom wear edge 72a of the intermediate wear edge 67 and the outer side wear edge 72 of the outer strips 66.

By being more aggressive, this embodiment significantly increases responsiveness of the snowmobile and the ability to turn on icy trail surfaces. The intermediate wear edge 67 comprising a sharp bottom wear edge 72a generally increases the amount of penetration into the trail surface by the wear rod 20 while turning and while moving in a generally straight direction. Additionally, this embodiment will typically present two sharp wear edges to the trail surface as the snowmobile ski 22 is turned and the wear rod 20 is canted, as explained previously. Presenting two sharp wear edges to the surface allows the snowmobile to make tighter turns and to make these tighter turns for an extended period of time. Unfortunately, this embodiment wears faster than the previous embodiment with a flat bottom wear surface. However, as the load of the snowmobile is not always completely carried by the intermediate wear edge 67, the wear life of the wear rod 20 is substantially longer than that of a wear rod with only a single edge. Also, rather than wearing round, the intermediate wear edge 67 will wear flat creating two new outer edges, similar to the corners 70 of FIG. 3, because the intermediate wear edge 67 is protected by the outer side wear edges 72. The outer side wear edges 72 in this embodiment will self sharpen in a similar manner as explained previously and illustrated in FIG. 9 for the outer edges of the previous embodiment.

FIGS. 5 and 6 illustrate further alternate embodiments of the wear rod 20 in FIG. 2. The wear rod 520 in FIG. 5 comprises many of the features and functions of the similar wear rod 20 in FIG. 3 except the flat bottom wear surface 568, two corners 570, sharp outer side wear edges 572 and two channels 565 are integrally formed in a single unitary body, thus providing for easier assembly. The functions and features of the three carbide strips 56 of FIG. 3 are performed and reproduced by a single carbide strip 556 as illustrated in FIG. 5. Furthermore, only a single groove 560 is required to mount the single carbide strip 556 to the host bar 540.

The wear rod 620 in FIG. 6 comprises many of the features and functions of the similar wear rod 20 in FIG. 4. In this embodiment, the sharp bottom wear edge 672a, sharp outer side wear edges 672 and two channels 665 are integrally formed in a single unitary body. Essentially, the functions and features of the three carbide strips 56 of FIG. 4 are performed and reproduced by a single carbide strip 656 as illustrated in FIG. 6. Furthermore, only a single groove 660 is required to mount the single carbide strip 656 to the host bar 640.

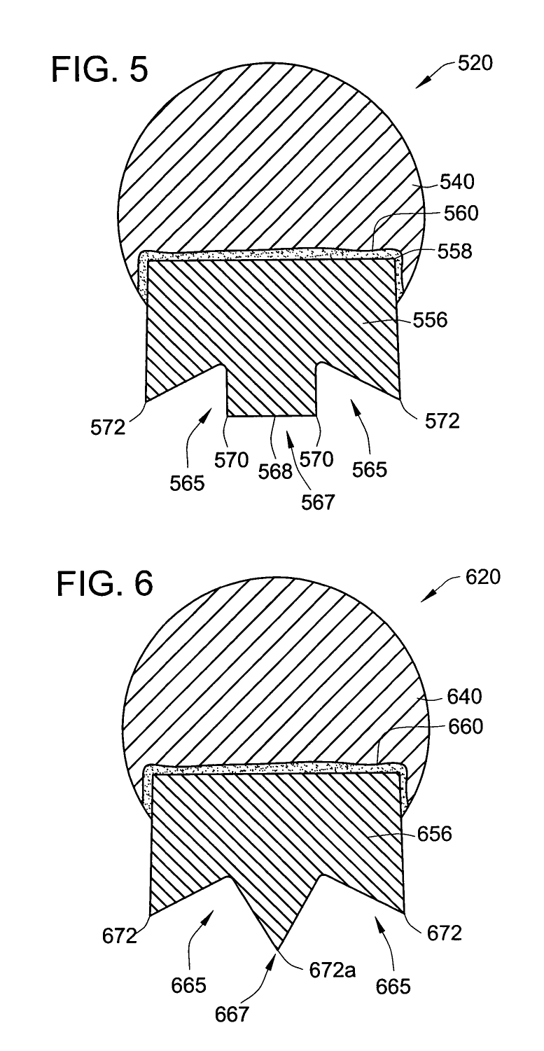

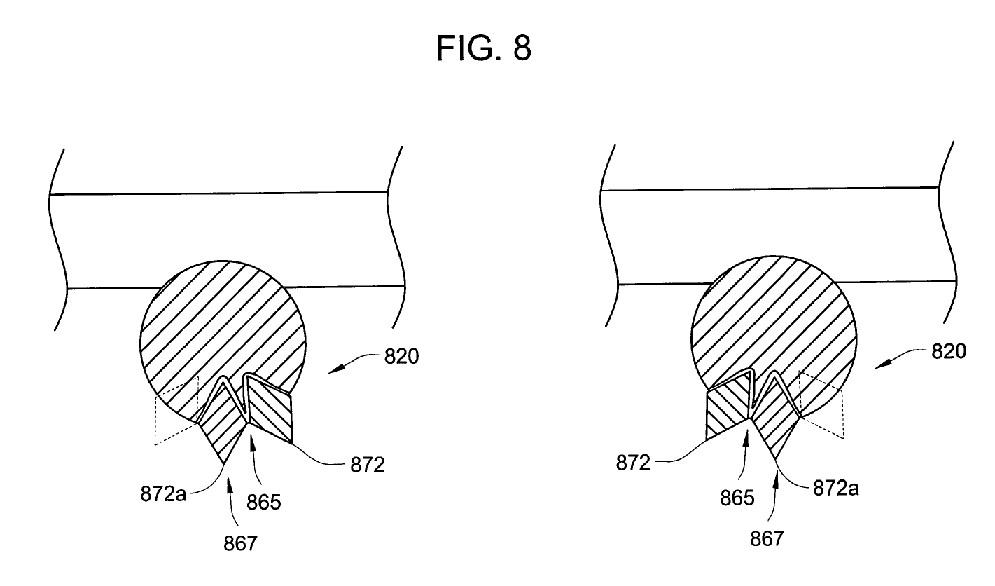

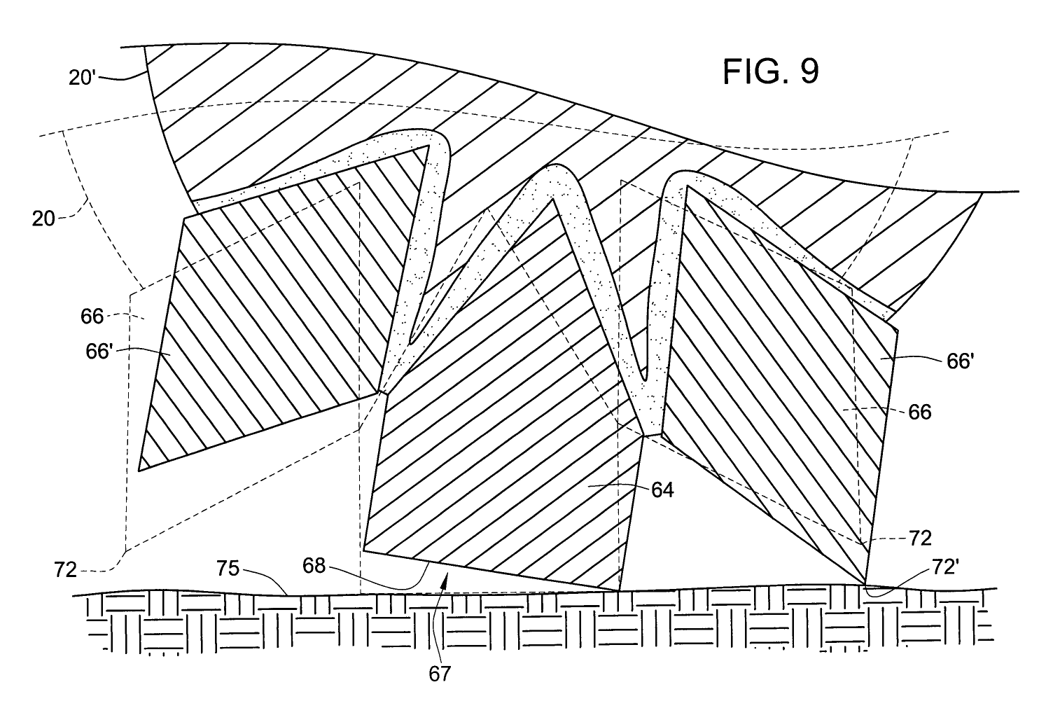

More economical wear rods, however which do not achieve certain advantages of other embodiments, include only two wear edges and a single channel therebetween. FIGS. 7 and 8 illustrate embodiments comprising multiple carbide strips and grooves. However, it should be noted that the configurations could be created using a single carbide strip and a single groove, similar to the embodiments in FIGS. 5 and 6.

FIG. 7 illustrates one such wear rod 720, which has two sharp outer side wear edges 772 of the outer strips 766 spaced substantially similar to the outer side wear edges 72 and outer strips 66 in FIGS. 3 and 4. A single channel 765 is formed therebetween. However, this embodiment does not include the intermediate strip 64 or intermediate wear edge 67, as in FIGS. 3 and 4. In this arrangement, some self sharpening occurs when the snowmobile moves in a straight direction because the outer strips 766 wear flat. Unfortunately, there is an increased rate of wear on the outer side wear edges 772 and increased wearing of the exposed area 774 of the host bar 740 between the outer strips 766, thereby, shortening the life of the wear rod 720. Also, as the wear bar 720 cants as the snowmobile ski turns, only a single outer side wear edge 772 of the wear rod 720 is presented to and engages the trail surface. Nevertheless, this embodiment achieves certain advantages and by requiring less machining and using less carbide material has economic rewards.

FIG. 8 illustrates a pair of wear rods 820, wherein each wear rod 820 is similar to the wear rod 20 of FIG. 4. However, each wear rod 820 only comprises an intermediate wear edge 867 forming a sharp bottom wear edge 872a and a single outer side wear edge 872 with a single channel 865 formed therebetween. In order to get at least one of the wear rods 820 to engage the trail surface with the two wear edges, namely 872 and 872a, simultaneously, no matter which direction the snowmobile turns, the embodiment requires the pair of wear rods 820 (one for each snowmobile ski) to have the pair of outer side wear edges 872 to be opposite of each other. In FIG. 8, the outer side wear edges 872 are located on the inside of the wear rod 820, between the pair of wear rods 820. In this configuration, the wear rod 820 attached to the snowmobile ski on the outside of the turn will present two wear edges, 872 and 872a, to engage the trail surface simultaneously. Having the two edges, 872 and 872a, engage the trail surface simultaneously on the snowmobile ski on the outside of the turn is beneficial because as the snowmobile turns the angular acceleration of the snowmobile shifts a substantial portion of the inside snowmobile ski's load to the outside snowmobile ski. Some turns are so tight and at such a high rate of speed, the inner snowmobile ski lifts entirely off the trail. The increased down force on the outer snowmobile ski makes it more influential to the turn, thus the proper side to have the additional edge engaging the trail surface.

One relatively skilled in the art would realize that the pair of outer side wear edges 872 may be located opposite of each other and on the outside of the wear rod 820, as illustrated by the dashed lines if FIG. 8. In this particular configuration, the snowmobile ski on the inside of the turn may potentially present two edges, namely 872 and 872a to the trail surface. However, for the reasons explained above this would not be the preferred arrangement.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A wear rod for a snowmobile ski, comprising:
a bar comprising a first material extending longitudinally;
at least one mounting structure adapted to mount wear rod to the ski;
at least one strip of a second material harder than the first material mounted to the bar and extending longitudinally adapted to increase wear resistance of the wear rod; and
at least two wear edges formed of the second material, the at least two wear edges being separated laterally by at least one longitudinally extending channel.

2. The wear rod of claim 1 wherein said at least two wear edges comprises at least three wear edges, including two outer side wear edges and an intermediate wear edge, and said at least one channel comprising at least two channels, each outer side wear edge being laterally separated from the intermediate wear edge by one of the channels.

3. The wear rod of claim 2 wherein said at least three wear edges and said at least two channels are integrally formed in a single unitary body of said second material.

4. The wear rod of claim 2 wherein said intermediate wear edge comprises a generally flat bottom wear edge being generally planar in the horizontal and having two corners, and said outer side wear edges comprise sharp edges.

5. The wear rod of claim 2 wherein said at least three wear edges are provided by at least three separate strips of the second material.

6. The wear rod of claim 1 further comprising at least two grooves extending longitudinally in lateral spaced relation, each groove having at least one strip of said second material soldered therein.

7. The wear rod of claim 3 further comprising at least one groove extending longitudinally and said single unitary body of said second material soldered in the at least one groove.

8. The wear rod of claim 2 wherein said intermediate wear edge is located at a vertical elevation between about 0 inch and about 0.05 inch below said outer side wear edges, and the outer side wear edges are located a horizontal distance between about 0.2 inch and about 0.3 inch from a vertical axis.

9. The wear rod of claim 8 wherein a plane defined by the intermediate wear edge and either of the outer side wear edges forms an angle α with a horizontal axis, said angle α being between about 8 degrees and about 15 degrees.

10. The wear rod of claim 2 wherein said intermediate wear edge projects vertically below the outer side wear edges a first predetermined distance, and the outer side wear edges being spaced laterally from a vertical axis a second predetermined distance, the first and second predetermined distances being selected such that tilting of the wear rod by a tilt angle when the ski, to which the wear rod is attached, turns results in the partial or entire shifting of the loads of the snowmobile from the intermediate wear edge to an outer side wear edge.

11. The wear rod of claim 1 wherein said at least one strip of second material comprises at least two strips of said second material mounted consecutively and end-to-end and said at least two wear edges are formed such that the entire longitudinal length of the wear edges is formed from multiple strips of the second material.

12. The wear rod of claim 1 wherein said first material comprises steel and said second material comprises carbide.

13. A wear rod for a snowmobile ski, comprising:
a host bar comprising steel extending longitudinally between a front end and a rear end and having an upwardly bent front end;
at least one threaded post integrally connected to the host bar adapted to mount the wear rod to the snowmobile ski;
at least one carbide strip comprising carbide material extending longitudinally along the host bar and being soldered to the host bar;
at least two wear edges of the carbide material, the at least two wear edges being laterally spaced and extending longitudinally a substantial length of the carbide strip in parallel relation and projecting downward; and
at least one channel laterally between the at least two wear edges.

14. The wear rod of claim 13 wherein said host bar further comprises at least one groove extending longitudinally substantially the length of the at least one carbide strip, said at least one carbide strip being mounted in the at least one groove with said solder.

15. The wear rod of claim 14 wherein said at least two wear edges comprises at least three wear edges, including two outer side wear edges and an intermediate wear edge and said at least one channel comprises two channels, each outer side wear edge being laterally separated from the intermediate wear edge by one of the two channels.

16. The wear rod of claim 15 wherein said at least one carbide strip comprises three individual carbide strips and said at least three wear edges comprises three wear edges wherein each of the at least three wear edges are separately formed from the three individual carbide strips, respectively.

17. The wear rod of claim 15 wherein said at least three wear edges and said at least two channels are integrally formed in a single unitary carbide strip.

18. The wear rod of claim 15 wherein said intermediate wear edge is a flat bottom wear edge being generally planar in the horizontal and said outer side wear edges are sharp edges.

19. The wear rod of claim 15 wherein said at least three wear edges are sharp edges.

20. The wear rod of claim 15 wherein said intermediate wear edge is located at a vertical elevation between about 0 inch and 0.05 inch below the outer side wear edges and the outer side wear edges are located a horizontal distance from a vertical axis about 0.2″ and about 0.3″.

21. The wear rod of claim 15 wherein a plane defined by the intermediate wear edge and either of the outer side wear edges forms an angle α with a horizontal axis, said angle α being between about 8 degrees and about 15 degrees.

22. The wear rod of claim 15 wherein said intermediate wear edge projects vertically below the outer side wear edges a first predetermined distance, and the outer side wear edges being spaced laterally from a vertical axis a second predetermined distance, the first and second predetermined distances being selected such that tilting of the wear rod by a tilt angle when a ski is turned results in the partial or entire shifting of the loads of the snowmobile from the intermediate wear edge to an outer side wear edge.

23. The wear rod of claim 13 wherein said at least one carbide strip comprises at least two carbide strips mounted consecutively and end to end, such that the entire longitudinal length of said at least two wear edges is formed from no less than two carbide strips.

24. The wear rod of claim 13 wherein said at least one carbide strip comprises at least two carbide strips extending longitudinally in parallel relation, each carbide strip forms a wear edge, the two wear edges being separated by at least one longitudinally extending channel.

25. The wear rod of claim 24 wherein said at least two wear edges and said channel are formed in a single unitary body of said at least one carbide strip such that the at least two wear edges are separated by the at least one channel.

26. A snowmobile ski for a snowmobile, comprising:
a substantially planar ski body comprising an upwardly bent front tip, a center keel and a connecting shoe for connecting the snowmobile ski to the snowmobile; and
a wear rod comprising a host bar comprising steel extending longitudinally between a front end and a rear end, having an upwardly bent front end and the bottom of the host bar having at least one groove extending longitudinally, at least one threaded post integrally connected to the host bar adapted to mount the wear rod to the ski, at least one carbide strip comprising a carbide material and being soldered in the groove, extending longitudinally substantially the length of the groove, at least two wear edges formed of the carbide material, the at least two wear edges extending longitudinally a substantial length of the carbide strip in parallel relation and at least one channel formed between the at least two wear edges.

27. The snowmobile ski of claim 26 wherein said at least two wear edges comprises at least three wear edges, including two outer side wear edges and an intermediate wear edge and said at least one channel comprises two channels, each outer side wear edge being separated from the intermediate wear edge by one of the two channels.

28. The snowmobile ski of claim 27 wherein each of said at least wear edges are separately formed from three individual carbide strips, respectively.

29. The snowmobile ski of claim 27 wherein said at least three wear edges and said at least two channels are integrally formed in a unitary body.

30. The snowmobile ski of claim 27 wherein said intermediate wear edge comprises a flat bottom wear edge being generally planar in the horizontal between two corners and said outer side wear edges are sharp edges.

31. The snowmobile ski of claim 27 wherein said at least three wear edges are sharp edges.

32. The snowmobile ski of claim 27 wherein said intermediate wear edge is located at a vertical elevation between about 0 inch and 0.05 inch below the outer side wear edges and the outer side wear edges are located a horizontal distance from a vertical axis about 0.2 inch and about 0.3 inch.

33. The snowmobile ski of claim 27 wherein a plane defined by the intermediate wear edge and either of the outer side wear edges forms an angle α with a horizontal axis, said angle α being between about 8 degrees and about 15 degrees.

34. The snowmobile ski of claim 27 wherein said intermediate wear edge projects vertically below the outer side wear edges a first predetermined distance, and the outer side wear edges being spaced laterally from a vertical axis a second predetermined distance, the first and second predetermined distances being selected such that tilting of the wear rod by a tilt angle when a snowmobile ski is turned results in the partial or entire shifting of the loads of the snowmobile from the intermediate wear edge to an outer side wear edge.
